(19) United States
(12) Patent Application Publication
(10) Pub. No.: US 2016/0107090 A1
(43) Pub. Date: Apr. 21, 2016

(54) Server Device

(71) Applicant: ALT INC., Tokyo (JP)

(72) Inventor: Kazutaka YONEKURA, Tokyo (JP)

(21) Appl. No.: 14/979,430

(22) Filed: Dec. 27, 2015

Related U.S. Application Data
(63) Continuation of application No. PCT/JP2014/066828, filed on Jun. 25, 2014.

(30) Foreign Application Priority Data
Jun. 26, 2013 (JP) 2013-133694

(51) Int. Cl. A63F 13/792; G06Q 20/38

(52) U.S. Cl. CPC A63F 13/792; G06Q 20/38

(57) ABSTRACT

A server device includes a group managing unit storing a group and a game player belonging to the group in association with each other; a point summing unit calculating points acquired by a game executed on a terminal device of the game player; a sales amount summing unit calculating sales amounts of items usable to execute the game; a money amount output unit outputting information on the sales amounts calculated by the sales amount summing unit to the terminal device executing the game; a group determining unit determining a group to be paid a part of, or the entirety of, the sales amounts as a result of the execution of the game; and an allocation determining unit determining allocation of the part of, or the entirety of, the sales amounts to be paid, in accordance with the points calculated for the game player stored in association with the determined group.

### CROSS-REFERENCE TO RELATED APPLICATIONS

This application is based upon and claims the benefit of priority from the prior Japanese Patent Application No. 2013-133694, filed on Jun. 26, 2013 and PCT International Application No. PCT/JP2014/066828, filed on Jun. 25, 2014, the entire contents of which are incorporated herein by reference.

### FIELD

The present invention relates to a server device or the like, and more specifically, a server device or the like that provides a terminal device of a game player with a game by which prize money or the like is paid.

### BACKGROUND

The processing capability of mobile terminals such as mobile phones and the like has been improved, and today, mobile terminals are capable of communicating with a server device to execute a game or the like. One type of such a game is a “social game”. A social game allows users to share the states of use thereof via a platform that holds certain account information on the Internet so as to encourage the users to complete. In such a social game, an “item” is used to allow a user to obtain an advantageous state over other users in the competition. For example, in a war game in which a plurality of opponents fights each other by use of a card, a card that allows the user to increase his/her fighting power is used as an item.

Some of the “items” can be purchased in change of a consideration. A player can proceed with the game advantageously by purchasing such an item. By purchasing such an item and using the item during the execution of a game, the player can proceed with the game advantageously and thus can enjoy the game for a long time. A game provider that administers a server device or the like obtains an income.

However, in a conventional social game, a reward for the user is intangible. Specifically, for example, the user is ranked high, or the user obtains an item that is only rarely obtainable. The value of such a reward is felt only by a user who actually played the game. In addition, even if a team of users has made an achievement, the reward may not be allocated in a manner that satisfies all the users belonging to the team.

### SUMMARY

An embodiment according to the present invention provides a server device including a group managing unit storing an identifier of a group and an identifier of a game player belonging to the group in association with each other; a point summing unit calculating a sum of points for the identifier of the game player, the points being acquired by a game executed on a terminal device owned by the game player; a sales amount summing unit calculating a sum of sales amounts of items usable to execute the game; a money amount output unit outputting information on the sum of the sales amounts calculated by the sales amount summing unit to the terminal device executing the game; a group determining unit determining a group to be paid a part of, or the entirety of, the sum of the sales amounts as a result of the execution of the game; and an allocation determining unit determining a manner of allocation of the part of, or the entirety of, the sum of the sales amounts to be paid, the manner of allocation being determined in accordance with the sum of the points calculated for the identifier of the game player stored in association with the identifier of the determined group.

An embodiment according to the present invention provides a server device including a group managing unit storing an identifier of a group and an identifier of a game player belonging to the group in association with each other; a point summing unit calculating a sum of points for the identifier of the game player, the points being acquired by a game executed on a terminal device owned by the game player; a sales amount summing unit calculating a sum of sales amounts of items usable to execute the game; a group determining unit determining a group to be paid a part of, or the entirety of, the sum of the sales amounts as a result of the execution of the game; and an allocation determining unit determining a manner of allocation of the part of, or the entirety of, the sum of the sales amounts to be paid, the manner of allocation being determined in accordance with the sum of the points calculated for the identifier of the game player stored in association with the identifier of the determined group.

An embodiment according to the present invention provides a server unit operation method including storing an identifier of a group and an identifier of a game player belonging to the group in association with each other; calculating a sum of points for the identifier of the game player, the points being acquired by a game executed on a terminal device owned by the game player; calculating a sum of sales amounts of items usable to execute the game; determining a group to be paid a part of, or the entirety of, the sum of the sales amounts as a result of the execution of the game; and determining a manner of allocation of the part of, or the entirety of, the sum of the sales amounts to be paid, the manner of allocation being determined in accordance with the sum of the points calculated for the identifier of the game player stored in association with the identifier of the determined group.

### BRIEF DESCRIPTION OF DRAWINGS

FIG. 1 is a functional block diagram of a system including a server device in an embodiment according to the present invention;

FIG. 2 is a flowchart showing a procedure of processes executed by the server device in the embodiment according to the present invention;

FIG. 3 shows an example of external appearance of a terminal device owned by a game player;

FIG. 4 shows an example of external appearance of the terminal device owned by the game player;

FIG. 5 is a flowchart showing a procedure of processes executed by the server device in the embodiment according to the present invention;

FIG. 6 is a flowchart showing a procedure of processes executed by the server device in the embodiment according to the present invention; and

FIG. 7 shows a sequence of processes executed by the system including the server device in the embodiment according to the present invention.

### DESCRIPTION OF EMBODIMENTS

Hereinafter, embodiments of the present invention will be described.

The present invention is not limited to any of the following embodiments, and the following embodiments may be modified in various manners to carry out the present invention.

The present invention has an object of providing a social game that provides a reward felt valuable by more people, and improves the manner of allocation of the reward in the case where a team of players has made an achievement.

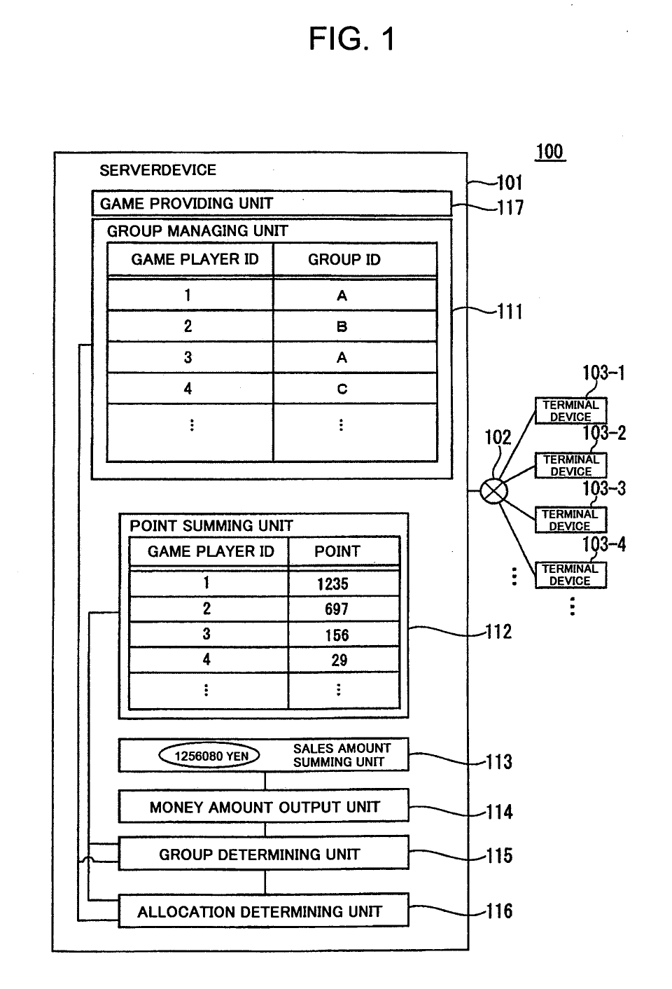

FIG. 1 is a functional block diagram of a system in an embodiment according to the present invention. A system 100 includes a server device 101, and terminal devices 103-1, 103-2, 103-3 and 103-4 connected with the server device 100 via a communication line 102. The server device 101 is managed by a game provider that provides game to game players that operate the terminal devices 103-1, 103-2, 103-3 and 103-4.

The communication line 102 may be a wired line, a wireless line, or a combination of a wired line and a wireless line. A typical example of the communication line 102 is a communication line for the Internet or mobile phones.

The terminal devices 103-1, 103-2, 103-3 and 103-4 may each be a mobile phone, a smart phone, a personal computer, a tablet terminal, or any other communication terminal. Preferably, each of the terminal devices 103-1, 103-2, 103-3 and 103-4 includes a browser and is capable of executing a game by use of a function of the browser. The terminal devices may each allow an application program usable to execute a game to be installed thereon. FIG. 1 shows four terminal devices 103-1, 103-2, 103-3 and 103-4, but any numbers of terminal devices are usable.

FIG. 1 shows one hardware device as the server device 101, but the server device 101 may include a plurality of hardware devices as necessary.

The server device 101 includes a group managing unit 111, a point summing unit 112, a sales amount summing unit 113, a money amount output unit 114, a group determining unit 116, an allocation determining unit 116, and a game providing unit 117.

The group managing unit 111 stores an identifier of a group. The group is formed of one or a plurality of game players. A game player uses one of the terminal devices 103-1, 103-2, 103-3, 103-4, . . . to play a game provided by the game providing unit 117 of the server device 101.

In an embodiment according to the present invention, the group managing unit 111 may store the identifier of the group and an identifier of a game player belonging to the group in association with each other. For example, as shown in FIG. 1, the group managing unit 111 holds a table including at least two columns, namely, the column of “game player identifier” and the column of “group identifier”. In this table, “1”, for example, is stored in a box of one row and the column of game player identifier and “A”, for example, is stored in a box of the same row and the column of group identifier. This indicates that a game player having an identifier of “1” belongs to a group having an identifier of “A”.

In order to join a group, a game player operates his/her own terminal device or another device. Then, the game player may create a new group to be the first game player belonging to the new group. Alternatively, the game player may search for existing groups and make an operation to join his/her favorite group. Still alternatively, the game player may receive, by use of a communication function via the server device 101 or the like, a message from a friend or someone he/she knows requesting the game player to join a group, and may make an operation to join the group in response to the request.

The point summing unit 112 calculates a sum of points acquired in the game. A game is provided by the game providing unit 117 and thus is executed by the terminal device owned by the game player. By playing the game, the game player is given a point. For example, in the case where the game provided by the game providing unit 117 is a fighting game by which the game player fights against another game player, the damage done to the another game player, namely, the opponent may be converted into a numerical value and the corresponding points may be given to the game player. In the case where the game provided by the game providing unit 117 is a puzzle game, the level achieved by the game player, for example, may be converted into a numerical value and the corresponding points may be given to the game player. In the case where the game provided by the game providing unit 117 is a fishing game or the like by which the game player acquires an object, the size or type of the acquired object by the game player may be converted into a numerical value and the corresponding points may be given to the game player.

The point summing unit 112 may calculate, for the identifier of the game player, a sum of the points acquired in the game executed by the terminal device owned by the game player. As shown in FIG. 1, the point summing unit 112, for example, holds a table including at least two columns, namely, the column of “game player identifier” and the column of “point”. In a box of one row and the column of “game player identifier”, “1” is stored, and in a box of the same row and the column of “point”, “1235” is stored. This indicates that the sum of the points acquired so far by the game player having the identifier of “1” by playing the game is 1235.

The sales amount summing unit 113 calculates a sum of sales amounts of items usable to execute the game. Based on the sum of the sales amounts calculated by the sales amount summing unit 113, a total sum of the sales amounts of the items sold to the game player identified by the identifier associated with the group having the identifier stored in the group managing unit 111 may be found. The sum of the sales amounts calculated by the sales amount summing unit 113 may be a sum of sales amounts of items sold to a game player other than the game player identified by the identifier associated with the group having the identifier stored in the group managing unit 111.

The money amount output unit 114 outputs and distributes information, on the sum of the sales amounts calculated by the sales amount summing unit 113, to the terminal device on which the game is being executed. As described later, the information on the sum of the sales amounts represents a part of, or the entirety of, the sum of the sales amount which is to be paid to the group that is determined. In the case where, for example, 2% of the sum of the sales amounts calculated by the sales amount summing unit 113 is to be paid to the group that is determined, the information represents 2% of the sum of the sales amounts calculated by the sales amount summing unit 113. The information representing such a money amount may not represent any specific numerical value. For example, the sum of the sales amounts calculated by the sales amount summing unit 113 may be divided by a constant to find a quotient, and the numerals at decimal places of the quotient may be truncated. An icon representing the resultant value may be information representing the money amount.

Preferably, each time a sum of the sales amounts is calculated by the sales amount summing unit 113, the money amount output unit 114 outputs and distributes the information on the sum of the sales amounts calculated by the sales amount summing unit 113 to the terminal device on which the game is being executed. This allows the game player to have the information on the sum of the sales amounts in real time, so that the game player has a further sense of anticipation for the allocation.

The group determining unit 115 determines the group to which a part of, or the entirety of, the sum of the sales amounts is to be paid as a result of the execution of the game. For example, the group determining unit 115 may calculate a total sum of the points acquired by the game players belonging to the group on a group-by-group basis, and may determine the groups to which the payment is to be made, in the order from the group having the largest total sum. For example, the group determining unit 115 may determine the group having the largest total sum as the group to which the payment is to be made.

In the case where the game providing unit 117 provides a fighting game, the group determining unit 115 may determine the group to which the payment is to be made after a sudden-death tournament or a round-robin tournament is performed. In the case where a sudden-death tournament is performed, if the payment is to be made to only the champion group, game players belonging to the groups that have lost at least once may possibly lose interest. Therefore, it is preferable that repechage matches are performed. It is preferable that the group determining unit 115 determines the groups at, for example, the second and the third positions as the groups to which the payment is to be made, in addition to the champion group.

It is also preferable that the game is played like in the Japanese Grand Sumo Tournament as follows. The groups fight each other once. Then, the groups are divided into two categories: a winner group category and a loser group category. The groups in the winner group category fight each other, and the groups in the loser group category fight each other. In this manner, the groups having generally the same winning ratio fight each other; namely, the groups of generally the same level fight each other. Thus, the game players more easily find the game enjoyable.

A part of, or the entirety of, the sum of the sales amounts which is to be paid to the group(s) determined by the group determining unit 115 may be always the same regardless of the sum of the sales amounts. Such an amount of money to be paid may be determined, for example, by the game provider before the start of the game. Alternatively, the amount of money to be paid to the group(s) determined by the group determining unit 115 may be matched to the sum of the sales amounts. However, in such a case, there may be a possibility that the game players are tempted too much to gamble to the level that is contrary to public order or morality. Thus, it is preferable that the amount of money to be paid is 2% or less of the sum of the sales amounts.

The allocation determining unit 116 determines the manner of allocation of a part of, or the entirety of, the sum of the sales amount which is to be paid to each of the group(s) determined by the group determining unit 115. The determination is made in accordance with the sum of the points calculated for the identifier of each of the game players stored in association with the identifier of each of the group(s) determined by the group determining unit 115. The “identifier of each of the game players stored in association with the identifier of each of the group(s) determined by the group determining unit 115” is an identifier of each of the game players stored, by the game managing unit 111, in association with the identifier of each of the groups determined by the group determining unit 115.

It is now assumed that, for example, the identifier of the group determined by the group determining unit 115 is “A”. In FIG. 1, the identifiers of the game players stored by the group managing unit 111 in association with “A” are “1” and “3”. The sum of the points calculated by the point summing unit 112 for the game player having the identifier of “1” is 1235, and the sum of the points calculated by the point summing. unit 112 for the game player having the identifier of “3” is 156. In the case where the identifiers of the game players stored by the group managing unit 111 in association with “A” are only “1” and “3”, the allocation determining unit 116 determines the manner of allocation of a part of, or the entirety of, the sum of the sales amounts which is to be paid to the group A in accordance with the points of 1235 and 156.

Referring to FIG. 1, it is now assumed that, for example, the amount of money to be paid that is stored as a result of the summing performed by the sales amount summing unit 113 is 1256080 yen. In this case, the allocation determining unit 116 determines to allocate 1235/(1235+156) of 1256080 yen to the game player having the identifier of “1” and to allocate 156/(1235+156) of 1256080 yen to the game player having the identifier of “3”.

According to the present invention, the amount of money does not need to be allocated in proportion to the points acquired by the game players. The allocation may not be performed in accordance with the points acquired by the game players belonging to a group. Instead, for example, the allocation may be performed in accordance with a rule (allocation rule) by which the game players who are at the first, second, third, fourth, fifth, sixth, seventh, eighth, ninth and 10th positions by the sum of the acquired points, among game players belonging to the group, respectively get 40%, 20%, 10%, 8%, 6%, 5%, 4%, 3%, 2% and 2% of the amount of money to be paid to the group. The ratio of the allocation may be determined by an administrator of the server device 101 in accordance with the number of the game players belonging to the group. Alternatively, the ratio of the allocation may be determined by a negotiation among the game players belonging to the group. Therefore, the allocation rule which defines the manner of allocation may be determined on a group-by-group basis. In the case where the allocation rule is determined in advance, the communication in the group may be promoted. According to the present invention, the allocation rule may be determined by any method.

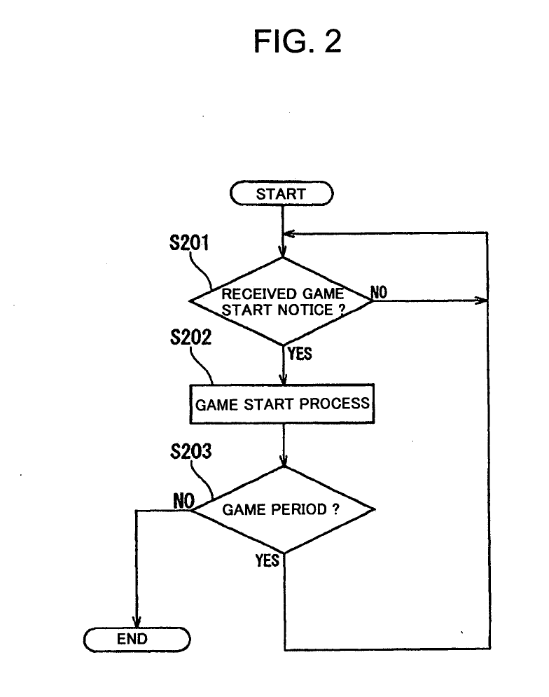

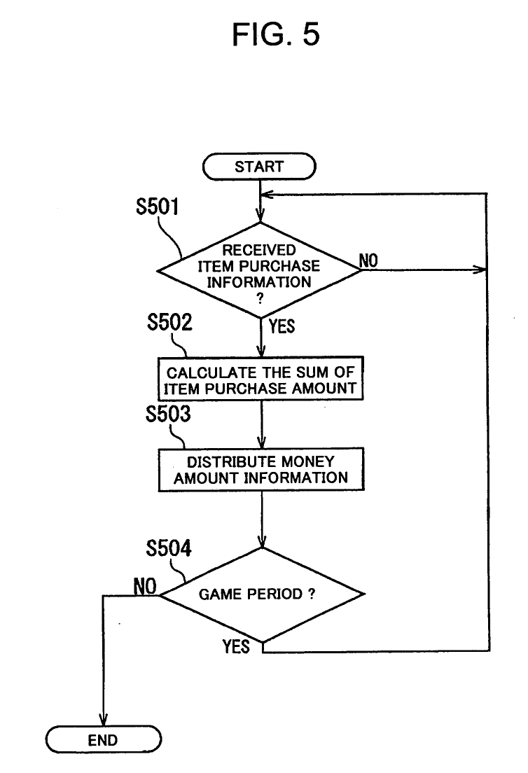

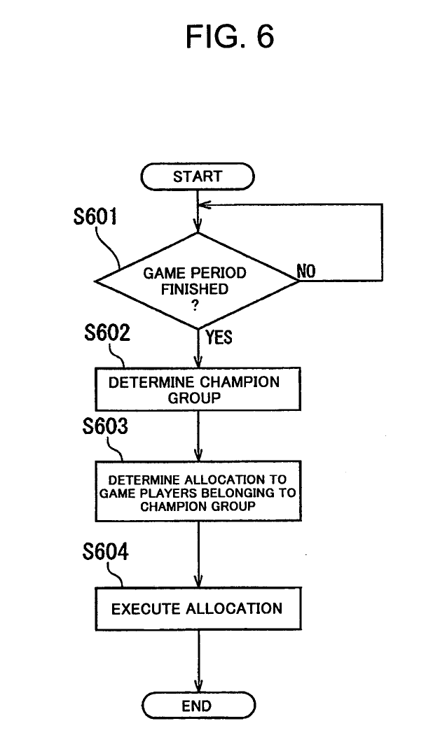

FIG. 2, FIG. 5 and FIG. 6 are flowcharts each showing a procedure of processes executed by the server device 101. In the server device 101, the procedures shown in these flowcharts are executed concurrently or in parallel. In the case where, for example, the server device 101 is realized by a computer, the procedure of the flowchart in FIG. 2, the procedure of the flowchart in FIG. 5, and the procedure of the flowchart in FIG. 6 are executed in the server device 101.

Referring to FIG. 2, in step S201, receipt of a game start notice from the terminal device is waited for. A game player makes an operation to start the execution of a game on his/her terminal device, so that the game start notice is transmitted from the terminal device to the server device 101.

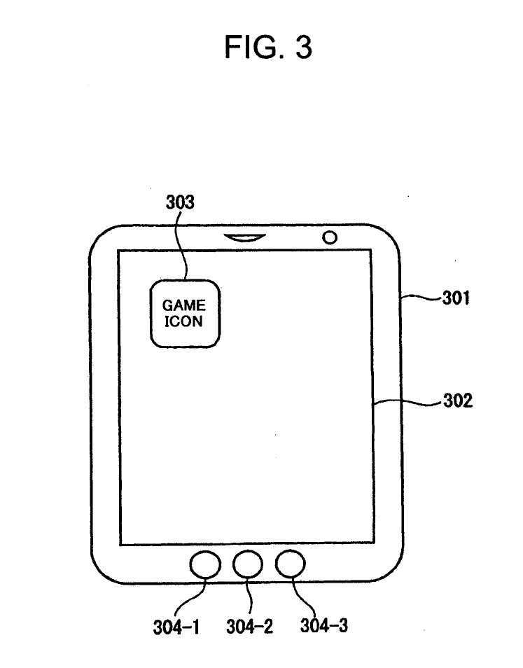

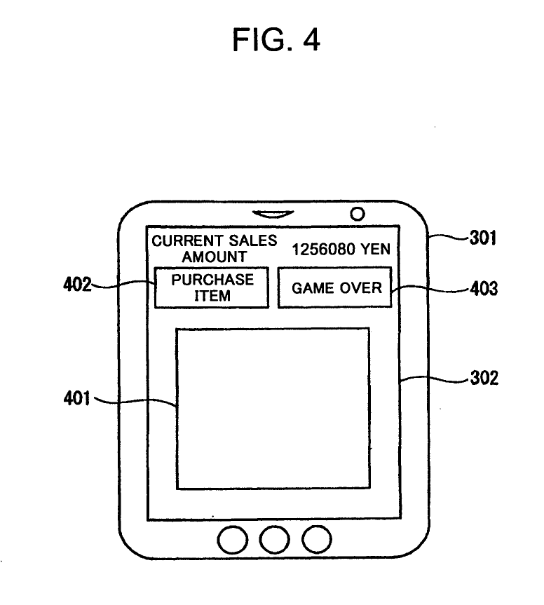

FIG. 3 shows an example of external appearance of a terminal device. A terminal device 301 includes a display 302 and operation buttons 304-1, 304-2 and 304-3. For example, the display 302 displays a game icon 303 usable to execute a game. The game icon 303 is, for example, tapped, so that a game screen shown in FIG. 4 is displayed on the display 302 and the game start notice is transmitted from the terminal device 301 to the server device 301. FIG. 4 will be described later.

Upon receipt of the game start notice by the server device 101, the procedure advances to step S202, in which a game start process is executed. The “game start process” is a process by which the game providing unit 117 starts providing the game to the terminal device that transmitted the game start notice. By the game start process, identification information or the like on the terminal device that transmitted the game start notice is stored in, for example, a storage area managed by the game providing unit 117. Also by the game start process, contents of the game are transmitted to the terminal device that transmitted the game start notice.

After the process of step S202, it is determined in step S203 whether or not a game period is still continued. The “game period” is a period of time in which a game player may play the game and the point summing unit 112 may calculate the sum of the points. When the game period is finished, the group determining unit 115 operates to determine the group(s).

In the case where the game period is continued, the procedure returns to step S201. In the case where the game period is finished, the procedure of the flowchart in FIG. 2 is terminated.

FIG. 4 shows an example of game screen displayed on the display 302 of the terminal device 301. In an upper part of the game screen, namely, in an upper part of the display 302, the sum of the sales amounts of the items that is output by the money amount output unit 114 is displayed as information on the sum of the sales amounts. When the game player operating the terminal device 301 or a game player operating another terminal device purchases an item, the information on the sum of the sales amounts is updated.

A button 402 is usable to purchase an item. When this button is selected, an item purchase screen (not shown) is displayed. The item purchase screen displays, for example, a list of items. When the game player selects an item and makes a payment for the price of the item, item purchase information is transmitted to the server device 101, and the sales amount adding unit 113 adds the sales amount of the item to the current sum of the sales amounts. Information on the purchased item is transmitted to the game providing unit 117, and the purchased item is added to an assembly of items that are, for example, owned by the game player. The game player is allowed to use the purchased item for the game and thus can proceed with the game advantageously.

FIG. 5 is a flowchart showing a procedure executed when the server device 301 receives the item purchase information. In step S501, receipt of the item purchase information is waited for. When the item purchase information is received, the procedure advances to step S502, in which the sales amount summing unit 113 executes a process of adding the sales amount of the item. The sales amount of the item is included in, for example, the item purchase information received by the process in step S501. Next, in step S503, the money amount output unit 114 outputs and distributes information on the sum of the sales amount to the terminal device on which the game is being executed. In step S504, it is determined whether or not the game period is still continued. In the case where the game period is continued, the procedure returns to step S501. In the case where the game period is finished, the procedure of the flowchart in FIG. 5 is terminated.

FIG. 6 is a flowchart showing a procedure executed when the game period is finished. In step S601, termination of the game period is waited for. When the game period is finished, the procedure advances to step S602, in which the group determining unit 115 determines the group(s). More specifically, a total sum of the points acquired by the game players belong to the group may be found on a group-by-group basis, and the group having the largest total sum may be determined as the champion group. When the group determining unit 115 determines the group(s), the procedure advances to step S603, in which the allocation determining unit 116 determines the allocation to each of the game players belonging to the determined group(s) (e.g., the champion group). The procedure advances to step S604, in which the allocation determined by the allocation determining unit 116 is executed. For example, a process of transferring money to the bank account designated by each game player is executed.

It is preferable that before the procedure advances to step S602, the procedure of the flowcharts in FIG. 2 and FIG. 5 are stopped to terminate the receipt of the game start notice and the receipt of the item purchase information.

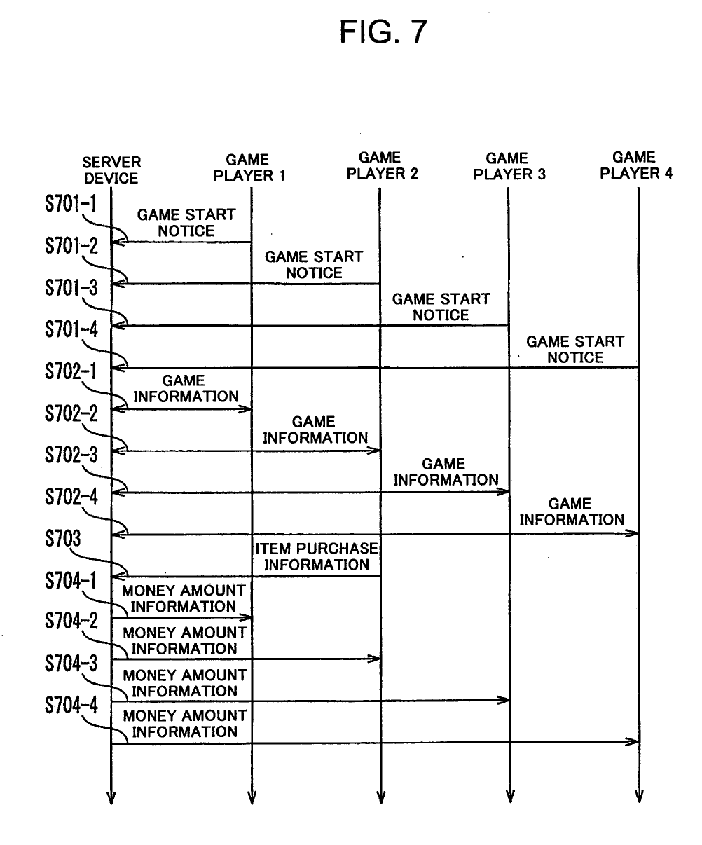

FIG. 7 shows an example of sequence of processes executed by the system 100. It is now assumed that there are four game players. In steps S701-1, S701-2, S701-3 and S701-4, the server device 101 receives a game start notice from each of the terminal devices operated by the game players. In the case of a fighting game or the like, an opponent is necessary. Therefore, there may be a case where the game is only allowed to be started at a certain time point and many game start notices are received at the same time at a certain time point. Nonetheless, the server device 101 does not need to receive, at the same time, the game start notices transmitted from the terminal devices operated by the game players, and may receive each game start notice from each terminal device at an arbitrary time point.

Upon receipt of the game start notices by the server device 101, game information is exchanged between the server device 101 and the terminal devices operated by the game players (steps S702-1, S702-2, S702-3 and S702-4). For example, game contents are transmitted from the server device 101 to the terminal devices operated by the game players, and the game is executed on the terminal devices operated by the game players. A video on the game is displayed on, for example, an area 401 of the display 302. When a certain game player acquires a point, it is notified to the server device 101 from the terminal device of the certain game player, and the point summing unit 112 calculates a sum of the points. Alternatively, information indicating what type of operation has been made on the terminal device is transmitted to the server device 101. A video on the game is generated by the server device 101, is transmitted to the terminal devices and is displayed on the area 401 or the like. As necessary, the point summing unit 112 calculates a sum of the points.

Then, for example, game player 2 presses the button 402 to purchase an item. In this case, in step S703, item purchase information is transmitted to the server device 101, and the sales amount summing unit 113 calculates a sum of the sales amounts. In steps S704-1, S704-2, S704-3 and S704-4, information on the sum of the sales amounts is distributed to the terminal devices of the game players.

When the game period is finished, the procedure of the flowchart in FIG. 6 is executed, the groups are determined, and the allocation to each of the game players belonging to the determined groups is determined. Then, the allocation is executed.

As described above, according to the present invention, a part of, or the entirety of, the total sum of the sales amounts is allocated to the game players. Therefore, the game players can enjoy the game without feeling any sense of unfairness.

The server device 101 may be realized by a computer including a CPU, a memory (temporary storage device), a secondary storage device, an input/output device, and a network interface. In this case, a program usable to realize the server device 101 may be stored on the secondary storage device, developed to the memory and executed by the CPU, so that the computer is operated as the server device 101. In such a case, a storage area for the group managing unit 111 and a storage area for the point summing unit 112 are provided in at least one of the memory and the secondary storage device. The tables shown in FIG. 1 are stored in these storage areas. Similarly, a storage area for the sales amount summing unit 113 is provided, and a sum of the sales amount is calculated.

The program executed by the CPU makes a communication with each of the terminal devices via the network interface to allow the terminal devices to execute the game. When a game player acquires a point along with the execution the game, the program adds the point to the sum of the points stored in the storage area for the point summing unit 112. When item purchase information is received via the network interface, the program adds the sales amount to the sum of the sales amounts stored in the storage area for the sales amount summing unit 113, and outputs and distributes the information on the sum of the sales amounts to the terminal devices that transmitted the game start notices via the network interface. When the game period is finished, the program reads the data in the storage area for the group managing unit 111 and the storage area for the point summing unit 112, determines the group(s), and determines the allocation to each of the game players belonging to the determined group(s).

The present invention provides a social game that that provides a reward felt valuable by more people, and improves the manner of allocation of the reward in the case where a team of players has made an achievement.

What is claimed is::

1. A server device, comprising:
a group managing unit storing an identifier of a group and an identifier of a game player belonging to the group in association with each other;
a point summing unit calculating a sum of points for the identifier of the game player, the points being acquired by a game executed on a terminal device owned by the game player;
a sales amount summing unit calculating a sum of sales amounts of items usable to execute the game;
a money amount output unit outputting information on the sum of the sales amounts calculated by the sales amount summing unit to the terminal device executing the game;
a group determining unit determining a group to be paid a part of, or the entirety of, the sum of the sales amounts as a result of the execution of the game; and
an allocation determining unit determining a manner of allocation of the part of, or the entirety of, the sum of the sales amounts to be paid, the manner of allocation being determined in accordance with the sum of the points calculated for the identifier of the game player stored in association with the identifier of the determined group.

2. The server device according to claim 1, wherein the group determining unit finds a total sum of the points calculated, as a result of the execution of the game, by the point summing unit for identifiers of game players belonging to each of groups on a group-by-group basis, and determines groups to be paid the part of, or the entirety of, the sum of the sales amount, in the order from a group having the largest total sum.

3. The server device according to claim 1, wherein the allocation determining unit determines the manner of allocation in accordance with an allocation rule defined on a group-by-group basis.

4. The server device according to claim 1, wherein the game is a fighting game to be fought between the group and an opponent group.

5. The server device according to claim 4, wherein the point represents damage done to a game player belonging to the opponent group in the fighting game.

6. The server device according to claim 1, wherein the point is obtained by converting a level achieved in a puzzle game into a numerical value.

7. The server device according to claim 1, wherein the point is obtained, in a game of acquiring an object, by converting a size of the acquired object into a numerical value.

8. The server device according to claim 1, wherein the point is obtained, in a game of acquiring an object, by converting a type of the acquired object into a numerical value.

9. The server device according to claim 1, further comprising a game providing unit providing a game to be executed by the terminal device.

10. The server device according to claim 9, wherein the game providing unit provides a fighting game, divides groups into a winner group category of groups winning in the fighting game and a loser group category of groups losing in the fighting game, and causing the groups in the winner group category to fight each other and causing the groups in the losing group category to fight each other.

11. The server device according to claim 1, wherein the part of the sum of the sales amounts to be paid to the group determined by the group determining unit is 2% or less of the sum of the sales amounts calculated by the sales amount summing unit.

12. The server device according to claim 2, wherein the group determining unit determines a group having the largest total sum, among total sums calculated, as a result of the execution of the game, by the point summing unit for identifiers of game players belonging to each of groups on a group-by-group basis.

13. A server device, comprising:
a group managing unit storing an identifier of a group and an identifier of a game player belonging to the group in association with each other;
a point summing unit calculating a sum of points for the identifier of the game player, the points being acquired by a game executed on a terminal device owned by the game player;
a sales amount summing unit calculating a sum of sales amounts of items usable to execute the game;
a group determining unit determining a group to be paid a part of, or the entirety of, the sum of the sales amounts as a result of the execution of the game; and
an allocation determining unit determining a manner of allocation of the part of, or the entirety of, the sum of the sales amounts to be paid, the manner of allocation being determined in accordance with the sum of the points calculated for the identifier of the game player stored in association with the identifier of the determined group.

14. The server device according to claim 13, wherein the group determining unit finds a total sum of the points calculated, as a result of the execution of the game, by the point summing unit for identifiers of game players belonging to the group on a group-by-group basis, and determines groups to be paid the part of, or the entirety of, the sum of the sales amount, in the order from a group having the largest total sum.

15. The server device according to claim 13, wherein the allocation determining unit determines the manner of allocation in accordance with an allocation rule defined on a group-by-group basis.

16. A server unit operation method, comprising:
storing an identifier of a group and an identifier of a game player belonging to the group in association with each other;
calculating a sum of points for the identifier of the game player, the points being acquired by a game executed on a terminal device owned by the game player;
calculating a sum of sales amounts of items usable to execute the game;
determining a group to be paid a part of, or the entirety of, the sum of the sales amounts as a result of the execution of the game; and
determining a manner of allocation of the part of, or the entirety of, the sum of the sales amounts to be paid, the manner of allocation being determined in accordance with the sum of the points calculated for the identifier of the game player stored in association with the identifier of the determined group.

17. The server unit operation method according to claim 16, wherein for determining groups to be paid the part of, or the entirety of, the sum of the sales amount as a result of the execution of the game, a total sum of the points is calculated for identifiers of game players belonging to each of groups on a group-by-group basis as a result of the execution of the game, and the groups are determined in the order from a group having the largest total sum.

18. The server unit operation method according to claim 16, wherein for determining the manner of allocation of the part of, or the entirety of, the sum of the sales amounts to be paid, in accordance with the sum of the points calculated for the identifier of the game player, the allocation is determined in accordance with an allocation rule defined on a group-by-group basis.

19. The server unit operation method according to claim 16, wherein the game is a fighting game having a plurality of groups fights each other.

20. The server unit operation method according to claim 16, further comprising outputting information on the sum of the calculated sales amounts to the terminal device executing the game.
